(19) United States
(12) Patent Application Publication
(10) Pub. No.: US 2015/0124462 A1
(43) Pub. Date: May 7, 2015

(54) LIGHT EMITTING DIODE DEVICE AND LIGHT EMITTING DIODE LAMP

(71) Applicant: Lextar Electronics Corporation, Hsinchu (TW)

(72) Inventor: Li-Cheng YANG, Zhongli City (TW)

(21) Appl. No.: 14/339,611

(22) Filed: Jul. 24, 2014

(30) Foreign Application Priority Data
Nov. 6, 2013 (TW) 102140370

(51) Int. Cl. F21V 19/00; F21K 99/00; F21V 21/00

(52) U.S. Cl. CPC F21V 19/0025; F21V 21/00; F21K 9/135
USPC 362/382

(57) ABSTRACT

A light emitting diode (LED) substrate includes a substrate body, a positive circuit and a negative circuit. The substrate body includes a light source disposing face having a main disposing surface and at least one sub-disposing surface, in which the at least one sub-disposing surface is disposed around the main disposing surface and has an inclined angle with the main disposing surface. The positive circuit and the negative circuit are buried inside the substrate body and connected to the main disposing surface and the sub-disposing surface.

### RELATED APPLICATIONS

This application claims priority to Taiwan Application Serial Number 102140370, filed Nov. 6, 2013, which is herein incorporated by reference.

### BACKGROUND

1. Field of Invention

The present invention relates to a light emitting diode substrate and a light emitting diode lamp.

2. Description of Related Art

Light emitting diode (LED) light bulb has gradually replaced the conventional incandescent light bulb and been broadly used for its economic power consumption feature. Nevertheless, light emitting elements of a conventional LED light bulb are basically arranged toward a front position such that all the light beams tend to be projected towards a single concentrated direction from the front position. Although the conventional LED light bulb may therefore have good concentrated illumination ability at the front, the luminance on the circumference of the LED light bulb has poor uniformity, which adversely affects the overall illumination performance.

The issue of poor uniformity on the circumference of the LED light bulb may be solved by bending the LED substrate which is used to carry the light-emitting elements. By arranging light-emitting elements on the bending substrate, the LED light bulb may uniformly emit light. However, it is difficult to bend the LED substrate into multiple different faces within limited space and thus, it is hard to manufacture an LED light bulb having multiple light emitting directions.

To improving heat dissipation efficiency, the LED substrate may be made of aluminum, an insulating glue and clutch gold which may be pasted on the surface of the aluminum substrate as a line layer. The insulating glue typically has poor ductility. During the bending of the aluminum substrate, the insulating glue may also peel off of the aluminum substrate, which may result in the damage of the line layer on the surface of the aluminum substrate.

### SUMMARY

Accordingly, one aspect of the present invention is to provide a light emitting diode (LED) substrate and a LED lamp, so as to solve the problems of the related art.

According to an embodiment of the invention, a LED substrate is provided. The LED substrate includes a substrate body, a positive circuit and a negative circuit. The substrate body includes a light source disposing face, a bottom face and a lateral face. The lateral face is connected between the bottom face and the light source disposing face. The light source disposing face includes a main disposing surface, at least one sub-disposing surface, and a plurality pairs of positive and negative electrode pads. The main disposing surface is parallel to the bottom face. The sub-disposing surface surrounds the main disposing surface and is at an inclined angle to the main disposing surface. The positive, negative electrode pads are formed on the main disposing surface and the sub-disposing surface respectively. The positive circuit and the negative circuit are buried inside the substrate body and are electrically connected with each pair of the positive and the negative electrode pads respectively.

According to an embodiment of the invention, the inclined angle is greater than 0 degree and smaller than 90 degrees.

According to an embodiment of the invention, the positive circuit and the negative circuit include a positive and a negative circuit channels and a metal material used to fill the positive and the negative circuit channels.

According to an embodiment of the invention, an aperture of the positive and the negative circuit channels is greater than 10 μm and less than 1 mm.

According to an embodiment of the invention, the filling of the metal material is performed by an evaporation or an electroplating process.

According to an embodiment of the invention, the light source disposing face, shaped by the main disposing surface and the at least one sub-disposing surface, bulges outward on its middle portion.

According to an embodiment of the invention, the light source disposing face, shaped by the main disposing surface and the at least one sub-disposing surface, hollows inward on its middle portion.

According to an embodiment of the invention, a material of the LED substrate is selected from the group consisting of aluminum oxide, aluminum nitride, boron nitride, and a combination thereof.

According to another embodiment of the invention, a LED lamp including the LED substrate mentioned above and a plurality of light emitting diodes (LEDs) is provided. The LEDs are disposed on the light source disposing face, and each of the LEDs electrically connected with one of pairs of the positive and negative electrode pads disposed on the main disposing surface or the sub-disposing surface.

According to another embodiment of the invention, the lamp base has a first end and a second end opposite to each other and the first end is configured to support the substrate body.

According to another embodiment of the invention, the lamp base further includes a power driving member electrical connected with the positive circuit and the negative circuit.

According to another embodiment of the invention, the LED lamp further includes a lamp cover covering the plurality of the LEDs.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a LED substrate in accordance with a first embodiment of the present invention.

FIG. 2 is a cross-sectional view of the LED substrate taken along line AA′ in FIG. 1.

FIGS. 3A-3C are a manufacture process of the LED substrate of FIG. 1.

FIG. 4 is a perspective view of the LED substrate in accordance with a second embodiment of the present invention.

FIG. 5 is a lateral view of LEDs being disposed on the LED substrate.

FIG. 6 is a LED lamp including the LED substrate of FIG. 1 in accordance with an embodiment of the present invention.

FIG. 7 is an assembling view of FIG. 6.

FIG. 8 is light emitting paths of the LED lamp in FIG. 7.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations. Wherever possible, the same reference numbers are used in the drawings and the description to refer to the same or like parts.

In following embodiments, a light emitting diode (LED) substrate having multiple light emitting faces is provided. The LED substrate in the following embodiments can be shaped into multiple different inclined faces by using a method of grinding. The LED light sources can be set on those grinding faces to emit the light beams on various angles. Furthermore, in the following embodiments, a metallic circuit lines can be configured inside the LED substrate before the grinding operation, so as to solve the problem of damaging the line layer while bending the aluminum substrate in related art.

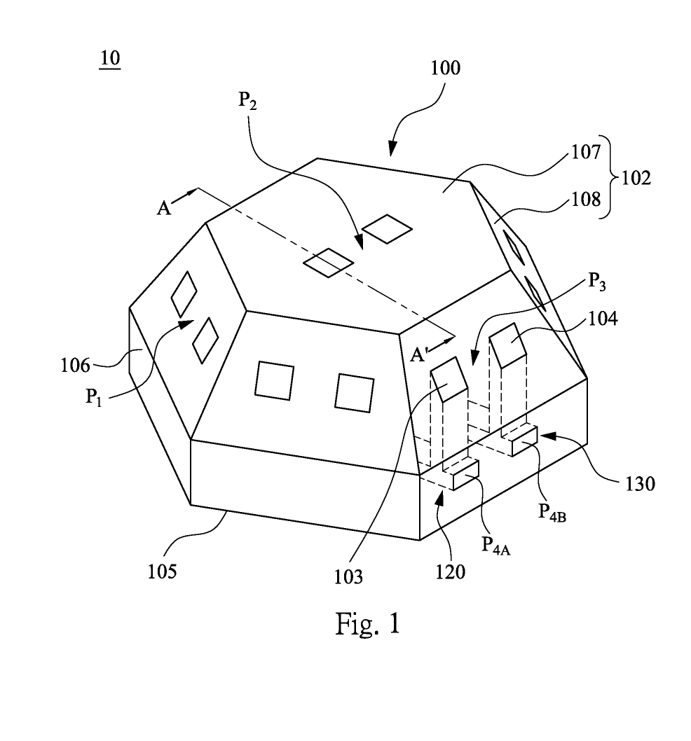

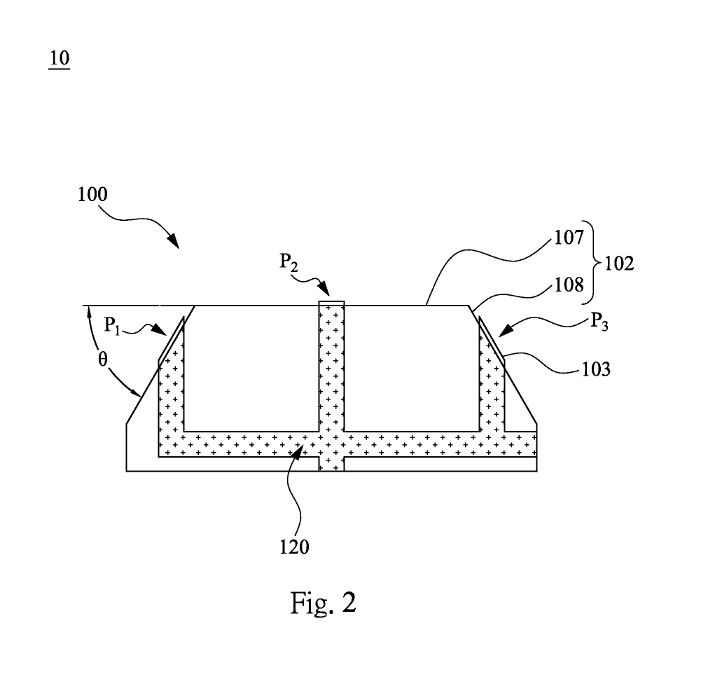

Please refer to FIG. 1 and FIG. 2, in which FIG. 1 illustrates a LED substrate in accordance with the first embodiment of the present invention and FIG. 2 illustrates a cross sectional view of FIG. 1 taken along line AA′. As illustrated, the LED substrate 10 includes a substrate body 100, a positive circuit 120 and a negative circuit 130. The substrate body 100 includes a light source disposing face 102. The light source disposing face 102 includes a plurality of different light emitting faces. Each light emitting face of the light source disposing face 102 has a positive electrode pad 103 and a negative electrode pad 104. The positive electrode circuit 120 and the negative electrode circuit 130 are buried inside the substrate body 100 and are electrically connected with the positive electrode pad 103 and the negative electrode pad 104 respectively.

The substrate body 100 further includes a bottom face 105 and a lateral face 106, in which the lateral face 106 is connected between the bottom face 102 and the light source disposing face 102. In present embodiment, the light source disposing face 102 includes a main disposing surface 107 and a plurality of sub-disposing surfaces 108. In case of FIG. 1, the main disposing surface 107 is hexagon shaped, and there are six sub-disposing surfaces 108 extended from an edge of the main disposing surface 107. In other embodiments of the present invention, the main disposing surface 107 can have circular shape and there may be only a single one sub-disposing surface 108 with annular shape.

The main disposing surface 107 is parallel to the bottom face 105. In present embodiment, the sub-disposing surfaces 108 surround the main disposing surface 107. Further, the light source disposing face 102 may be shaped by the main disposing surface 107 and the sub-disposing surfaces 108, and the light source disposing face 102 may bulge outward on its middle portion. As illustrated in FIG. 2, there is an inclined angle θ between the sub-disposing surfaces 108 and the main disposing surface 107. In the present disclosure, the inclined angle θ is a supplementary angle of the lesser angle between the main disposing surface 107 and the sub-disposing surfaces 108 in present embodiment and the following embodiments.

In present embodiment, the inclined angle θ is greater than 0 degree and less than 90 degrees. The positive circuit 120 and the negative circuit 130 are formed inside the substrate body 100 in advance, and then using grinding means to manufacture the sub-disposing surfaces 108 having the inclined angle θ with the main disposing surface 107.

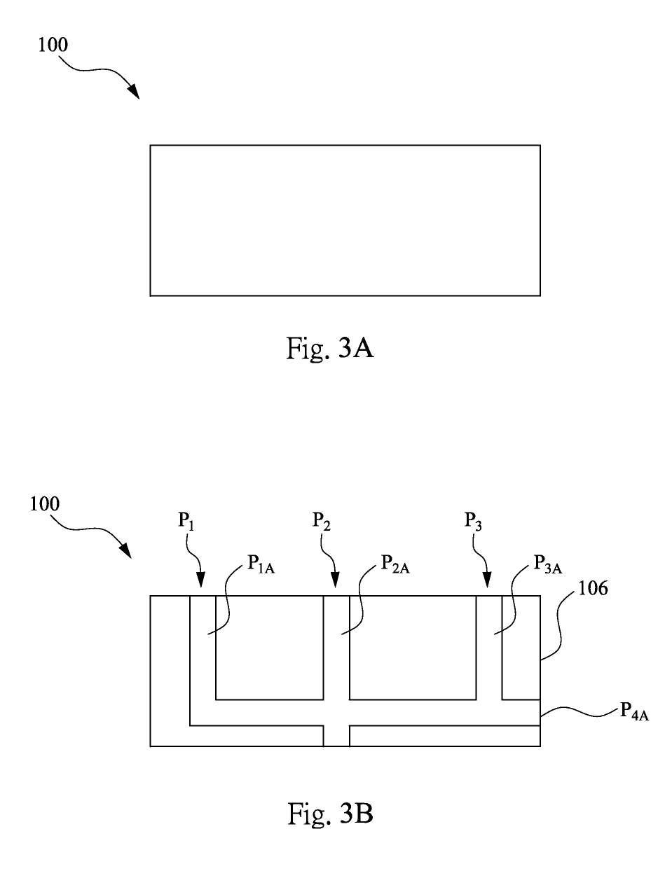

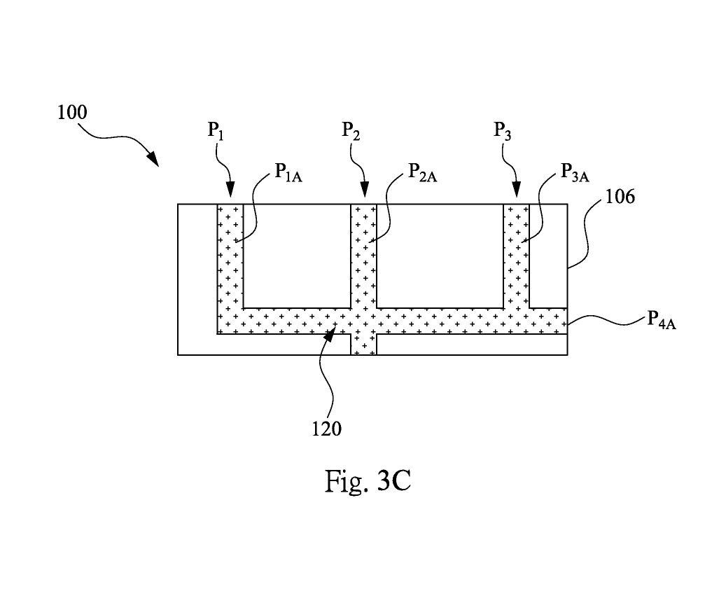

For further comprehension of the invention, a manufacturing method of the LED substrate in the embodiment of FIG. 1 will be explained as an example herein. Please refer to FIGS. 3A-3C, which illustrates a cross sectional view of manufacturing process in accordance with the embodiment of FIG. 1. As illustrated in FIG. 3A, a substrate body 100 made of ceramics may be prepared at first, in which a grinding process has not yet been performed upon substrate body 100. The material of the LED substrate 100 may be selected from the group consisting of aluminum oxide (Al₂O₃), aluminum nitride (AlN), boron nitride (BN), and a combination thereof.

Next, as illustrated in FIG. 3B, the manufacturing method of LED substrate 100 further includes: determining a plurality of drilling positions P₁, P₂, and P₃ (shown by the arrows), and using a method of laser drilling, mechanical drilling or sintered drilling to form pairs of holes P_{1A}, P_{2A}, P_{3A}, inside the substrate body 100 relative to the drilling positions P₁, P₂, and P₃, in which the hole at position P₂ may penetrate through the whole substrate body 100, but is not limited thereto. In other embodiments of the present invention, the drilling positions P₁ or P₃ may be chosen to penetrate through the whole substrate body 100. Next, the lateral face 106 of the substrate body 100 can form channels P_{4A}, P_{4B} (shown in FIG. 1), in which the channel P_{4A} connects to the same side of pair holes P_{1A}, P_{2A}, P_{3A} and the channel P_{4B} connects to the other side of pair holes P_{1A}, P_{2A}, P_{3A}.

Next, as illustrated in FIG. 3C, by using an evaporation or an electroplating process, a metal material can be filled into the holes P_{1A}, P_{2A}, P_{3A} and the channel P_{4A}, in which the holes P_{1A}, P_{2A}, P_{3A} and the channel P_{4A} can be regarded as a positive circuit channel and thus after the holes P_{1A}, P_{2A}, P_{3A} and the channel P_{4A} are filled with the metal material, the positive circuit 120 of the substrate body 100 is formed. In other words, the positive electrode circuit 120 includes the positive circuit channel and the metal material filled the positive circuit channel. Similarly, the formation of the negative circuit 130 is the same with the positive circuit 120 and its description will be omitted herein.

It is worthy to mention that in the present embodiment, the aperture of the positive and the negative circuit channels is 100 μm, but is not limited thereto. In other embodiments of the present invention, the aperture of the positive and the negative circuit channels is greater than 10 μm and less than 1 mm. In practical use, if the aperture of positive and the negative circuit channels is less than 10 μm, the curved part of the channels may be difficult to use an evaporation process, or be electroplate with a metal material. If the aperture of positive and the negative circuit channels is greater than 1 mm, the cost of manufacturing substrate body 100 may be too high. However, the above manufacture or cost issue is not limited the scope of the present invention. A person ordinarily skilled in the art may produce the positive and the negative circuit channels having aperture larger than 1 mm or less than 10 μm without considering the cost or omitting the evaporation or electroplating difficulties.

Next, after finishing the evaporation or electroplating process of the metal material, a grinding process can be performed on the surface of the light source disposing face 102 and a positive and negative electrode pads 103, 104 (illustrated in FIG. 1) may be formed on an open part of the holes P_{1A}, P_{2A}, P_{3A}, thereby forming a lateral view of LED substrate 100 in FIG. 2. As a result, the LED substrate 10 of the present embodiment has multiple light emitting faces with the metal lines buried inside the substrate body 100, and it is not necessary to arrange an additional line layer on the surface of the substrate body 100.

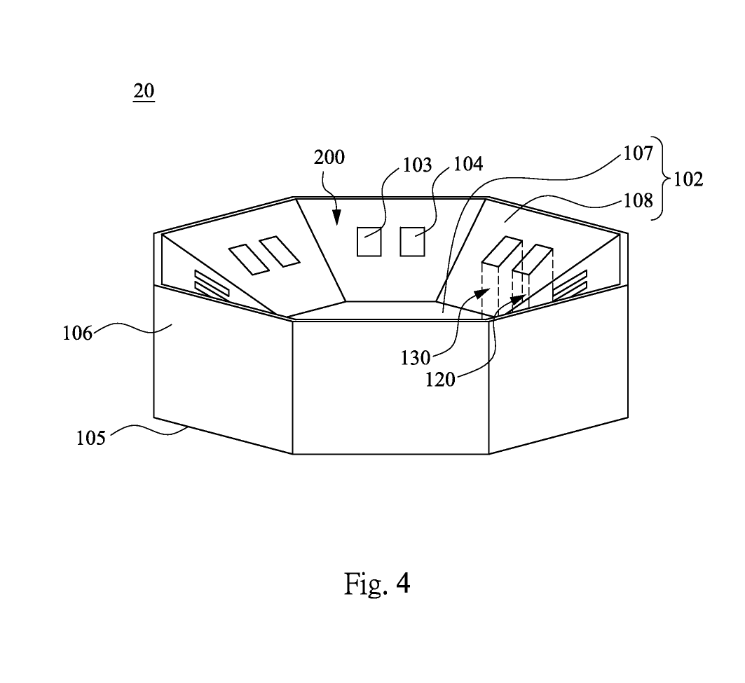

Next, please refer to FIG. 4, which illustrates a LED substrate in accordance with the second embodiment of the present invention. As illustrated, the differences of the LED substrate 20 of the present embodiment with first embodiment is that the light source disposing face 102 of the present embodiment, shaped by the main disposing surface 107 and the sub-disposing surfaces 108, may hollow inwardly from its middle portion. That is, the substrate body 100 of the present embodiment may have a concave area 200, in which the main disposing surface 107 and the sub-disposing surfaces 108 can be considered as a bottom surface and the side walls of the concave area 200.

Furthermore, the positive circuit 120 and the negative circuit 130 are buried inside the substrate body 100, and the main disposing surface 107 and each sub-disposing surface 108 has a pair of positive and a negative electrode pads 103, 104, in which the positive circuit 120 and the negative circuit 130 are electrically connected with each pair of positive and negative electrode pads 103, 104 respectively, so that the LED substrate 20 of the present embodiment can emit the light beams with multiple faces and its metal lines are buried inside the substrate body 100.

It should be explained that, the manufacturing method of the LED substrate 20 of the present embodiment is similar to the first embodiment, which is to form the positive and the negative circuit channels inside the substrate body 100 and the positive circuit 120 and the negative circuit 130 is formed by filling the metal material into the positive and the negative circuit channels by an evaporation or an electroplating process; and finally the sub-disposing surfaces 108 are formed by performing the grinding process, so as to produce the LED substrate 20 of the present embodiment.

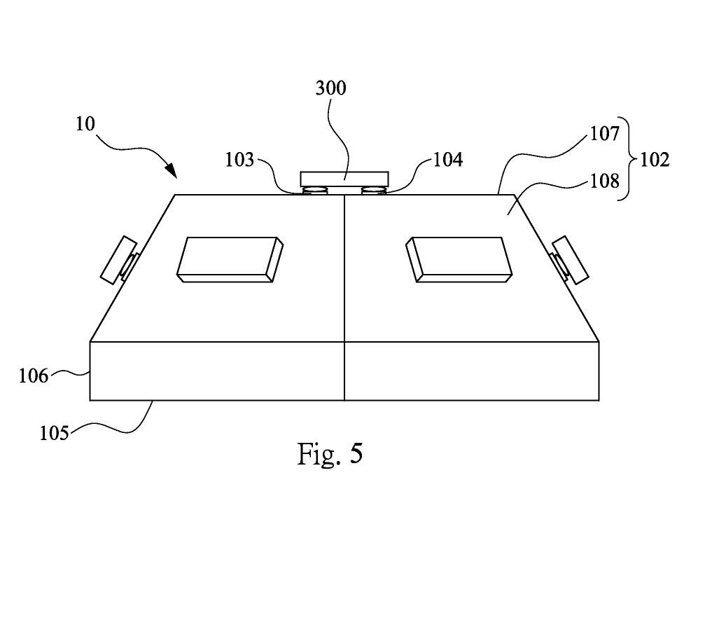

Please refer to FIG. 5, which illustrates a lateral view of light emitting diodes (LEDs) being disposed on the LED substrate. As illustrated, the LEDs 300 may be electrically connected to the positive and the negative electrode pads 103, 104 of the LED substrate 10 by using a flip-chip process, but are not limited thereto. In other embodiments of the present invention, a wire bonding process may be applied to electrical connected the vertical type or the face-up type of LEDs 300 with the positive and the negative electrode pads 103, 104 of the LED substrate 10.

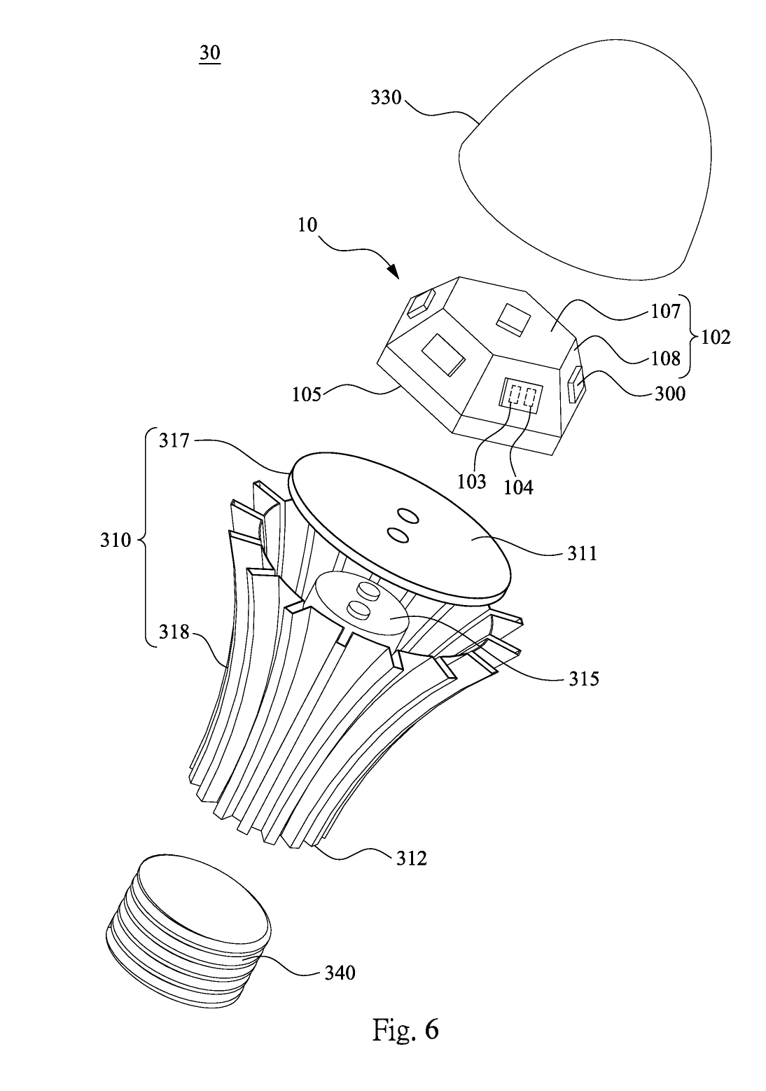

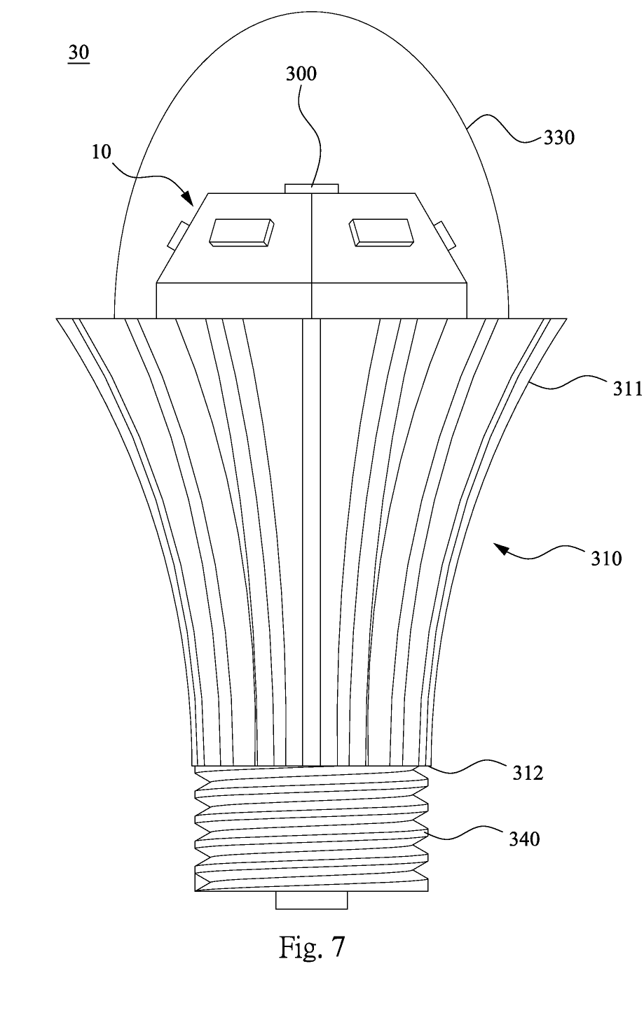

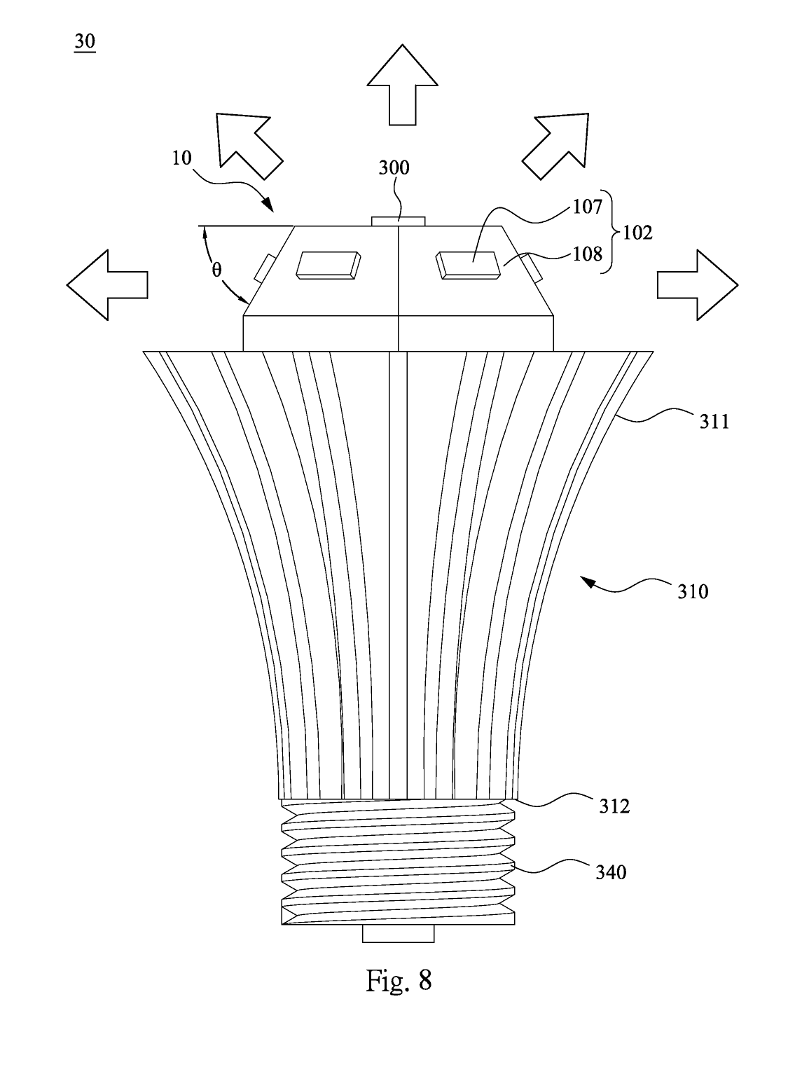

Next, please refer to FIG. 6 and FIG. 7, in which FIG. 6 illustrates a LED lamp including the LED substrate of FIG. 1 in accordance with an embodiment of the present invention, and FIG. 7 illustrates an assembling view of FIG 6. As illustrated, the LED lamp 30 includes the LED substrate 10 of the first embodiment and a plurality of LEDs 300. Each of the LEDs 300 are disposed on the light source disposing face 102, and each of the LEDs 300 are electrical connected to a pair of positive and negative electrode pads 103, 104 disposed on the main disposing surface 107 or the sub-disposing surface 108.

As illustrated in FIG. 6 and FIG. 7, the LED lamp 30 further includes a lamp base 310, a lamp cover 330 and an electrical connector 340. The lamp base 310 includes a first end 311 and a second end 312 opposite to each other. The first end 311 is configured to support the substrate body 100. In more detail, the lamp base 310 further includes a supporting plate 317 and a base portion 318, in which the first end 311 may refer to the top surface of the supporting plate 317. The top surface of the supporting plate 317 is contacted to the bottom face of the substrate body 100, so as to support the substrate body 100 and further dissipate the heat of the LEDs 300. The second end 312 may refer to the bottom surface of the base portion 318. The second end 312 of the lamp base 310 is used to connect to the electrical connector 340. The lamp base 310 further includes a power driving member 315 disposed inside the base portion 318 and electrically connected between the electrical connector 340 and the positive, negative circuits 120 130, so as to convert an external AC current into a desired current source for driving the LEDs 300 to emit the light beams. For example, when the lamp base 310 and the LED substrate 10 are assembled together, the two power contact points of the power driving member 315 can be connected to the part of the positive and the negative circuits 120, 130 that exposed on middle position of the bottom face 105 of the substrate body 100 via the two holes of the supporting plate 317. The lamp cover 300 covers the plurality of the LEDs 300.

Next, please refer to FIG. 8, which illustrates a light emitting path of the LED lamp 30 of FIG. 7. For clearly description of the invention, the lamp cover 300 in FIG. 7 is omitted to illustrate. As illustrated in FIG. 8, when the LED lamp 30 emits the light, because the main disposing surface 107 of the light source disposing face 102 bulges relative to the sub-disposing surface 108 and the sub-disposing surface 108 surrounds the main disposing surface 107 and has an inclined angle θ with the main disposing surface 107, the LED substrate 10 accordingly can emit the light beams from various angles.

It should be understood that, the LED substrate 10 of the first embodiment is taken as an example in the present embodiment but in other embodiments of the present invention, the LED substrate 20 of the second embodiment may be applied to the LED lamp 30 as well, so as to emitting the light beams from various angles.

As discussed above, the LED substrate of above embodiments includes the main disposing surface and the sub-disposing surface that is inclined to the main disposing surface; therefore, the LED substrate can have various light emitting angles. Furthermore, the metal lines of the LED substrate of above embodiments can be buried inside the substrate body. Hence, there is no necessary to arrange additional line layer on the surface of the substrate body or to bend the substrate body to manufacture various light emitting angles. Accordingly, an issue of damaging the line layer in related art caused by bending the substrate body can be solved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light emitting diode (LED) substrate, comprising:
a substrate body, comprising a light source disposing face, a bottom face and a lateral face, in which the lateral face is connected between the bottom face and the light source disposing face, the light source disposing face comprising:
a main disposing surface parallel to the bottom face;
at least one sub-disposing surface, surrounding the main disposing surface and having an inclined angle with the main disposing surface; and
a plurality pairs of positive and negative electrode pads formed on the main disposing surface and the sub-disposing surface respectively; and
a positive circuit and a negative circuit buried inside the substrate body and electrically connected with each pair of the positive and the negative electrode pads respectively.

2. The LED substrate of claim 1, wherein the light source disposing face, shaped by the main disposing surface and the at least one sub-disposing surface, bulges outward on its middle portion.

3. The LED substrate of claim 1, wherein the light source disposing face, shaped by the main disposing surface and the at least one sub-disposing surface, hollows inward on its middle portion.

4. The LED substrate of claim 1, wherein the inclined angle is greater than 0 degree and smaller than 90 degrees.

5. The LED substrate of claim 1, wherein the positive circuit and the negative circuit comprise a positive and a negative circuit channels and a metal material used to fill the positive and the negative circuit channels.

6. The LED substrate of claim 5, wherein an aperture of the positive and the negative circuit channels is greater than 10 μm and less than 1 mm.

7. The LED substrate of claim 6, wherein the filling of the metal material is performed by an evaporation or an electroplating process.

8. The LED substrate of claim 1, wherein a material of the LED substrate is selected from the group consisting of aluminum oxide, aluminum nitride, boron nitride, and a combination thereof.

9. A LED lamp, comprising:
a LED substrate, comprising:
a substrate body, comprising a light source disposing face, a bottom face and a lateral face, in which the lateral face is connected between the bottom face and the light source disposing face, the light source disposing face comprising:
a main disposing surface parallel to the bottom face;
at least one sub-disposing surface, surrounding the main disposing surface and having an inclined angle with the main disposing surface; and
a plurality pairs of positive and negative electrode pads formed on the main disposing surface and the sub-disposing surface respectively; and
a positive circuit and a negative circuit buried inside the substrate body and electrically connected with each of pairs of the positive and the negative electrode pads respectively; and
a plurality of LEDs disposed on the light source disposing face, and each of the LEDs electrically connected with one of pairs of the positive and negative electrode pads disposed on the main disposing surface or the sub-disposing surface.

10. The LED lamp of claim 9, further comprising a lamp base having a first end and a second end opposite to each other, wherein the first end is configured to support the substrate body.

11. The LED lamp of claim 10, wherein the lamp base further comprises a power driving member electrically connected with the positive circuit and the negative circuit.

12. The LED lamp of claim 11, further comprising a lamp cover covering the plurality of the LEDs.
